(19) United States
(12) Patent Application Publication
(10) Pub. No.: US 2023/0274372 A1
(43) Pub. Date: Aug. 31, 2023

(54) METHOD AND APPARATUS FOR PROVIDING TAX PREPARATION SERVICES OVER A COMMUNICATIONS NETWORK

(71) Applicant: Eddy Aladin, Palm Beach, FL (US)

(72) Inventor: Eddy Aladin, Palm Beach, FL (US)

(21) Appl. No.: 18/175,170

(22) Filed: Feb. 27, 2023

Related U.S. Application Data
(60) Provisional application No. 63/314,049, filed on Feb. 25, 2022.

(51) Int. Cl. G06Q 40/12

(52) U.S. Cl. CPC G06Q 40/123

(57) ABSTRACT

A computing system for providing tax preparation services to a user over a communications network includes for storing user records and tax preparation records, a web server including an operating system-level virtualization platform configured for hosting and executing a plurality of containers, and for dynamically scaling said plurality of containers according to user demand for said plurality of containers, a first container executing on the platform for allowing the user to prepare this tax returns, a second container executing on the platform for allowing the user to request an in-person visit between the user and a tax professional and a third container executing on the platform for allowing the user to request a virtual conference between the user and a tax professional.

### CROSS-REFERENCE TO RELATED APPLICATIONS

This patent application claims priority to provisional patent application 63/314,049 filed Feb. 25, 2022, and entitled “Method and apparatus for providing tax preparation services over a communications network.” The subject matter of provisional patent application 63/314,049 is herby incorporated by reference in its entirety.

STATEMENT REGARDING FEDERALLY SPONSORED RESEARCH OR DEVELOPMENT

### Not Applicable.

### INCORPORATION BY REFERENCE OF MATERIAL SUBMITTED ON A COMPACT DISC

Not Applicable.

### TECHNICAL FIELD

The claimed subject matter relates to the field of electronic commerce and, more specifically, the claimed subject matter relates to the field of financial services using computing devices on a communications network.

### BACKGROUND

Financial services is a broad term used to describe the various offerings within the finance industry—encompassing everything from insurance and money management to tax filings and banking. There are a multitude of parties within financial services, from credit card issuers and processors, to banks and accountants. And with financial activity becoming increasingly digitized, especially as consumers are choosing to manage their finances from home amid the ongoing pandemic, financial institutions and service providers are sharpening their technology and expanding remote services.

One area of the financial services industry that has been changing is tax preparation. Typically, tax preparation involves a consumer visiting an accountant in person reviewing physical hard copies of documents comma and then having a tax return being prepared by the accountant. With the advent of the Internet and the large amounts of bandwidth, tax preparation is now easier to do online or virtually. There are few if any solutions, however, on the market for consumers that start the tax preparation process on their own but then find out during the process that they do, in fact, need a tax professional to complete the process. This has been compounded by the fact that the ongoing pandemic has forced many consumers to accomplish tasks at home online.

The financial services industry includes many other sectors including those sectors that provide credit cards and charge cards to consumers, assistance in tax preparation, real estate services, credit services, payroll services, health insurance services, and financial education services. It can be tedious and time-consuming, however, to access and interact with many different people and software in order to get all of the services above. To date, there is no single provider of all of the services above.

Therefore, what is needed is a system and method for improving the problems with the prior art, and more particularly for a more expedient and efficient method and system for providing financial services, such as tax preparation, online.

### BRIEF SUMMARY

In one embodiment, a computing system for providing tax preparation services to a user over a communications network is disclosed. The computing system includes a database configured for storing a plurality of user records and tax preparation records; a web server communicably connected to the communications network and to the database, the web server including: a) an operating system-level virtualization platform configured for hosting and executing a plurality of containers, and for dynamically scaling said plurality of containers according to user demand for said plurality of containers; b) a first container executing on said platform, the first container configured for: 1) providing, over the communications network, a user interface configured for allowing the user to enter user data and tax preparation data; 2) reading, over the communications network, user data and tax preparation data entered by the user into the user interface; 3) storing said user data and said tax preparation data in one or more user records and tax preparation records in the database; 4) generating one or more tax return documents based on said user data and said tax preparation data; 5) transmitting, over the communications network, the tax return documents to a tax authority; c) a second container executing on said platform, the second container configured for: 1) broadcasting, over the communications network, a message to a group of available tax professionals licensed in a jurisdiction of the user, the message indicating availability of the user; 2) receiving, over the communications network, an acceptance from a particular tax professional licensed in the jurisdiction of the user; 3) initiating, over the communications network, an in-person visit between the user and the particular tax professional; 4) providing, over the communications network, a user interface configured for allowing the particular tax professional to enter user data and tax preparation data; 5) providing, over the communications network, an automated process that facilitates entry of user data and tax preparation data into the user interface; 6) storing said user data and said tax preparation data in one or more user records and tax preparation records in the database; 7) generating one or more tax return documents based on said user data and said tax preparation data; and 8) transmitting, over the communications network, the tax return documents to the tax authority; and d) a third container executing on said platform, the third container configured for: 1) broadcasting, over the communications network, a message to a group of available tax professionals licensed in a jurisdiction of the user, the message indicating availability of the user; 2) receiving, over the communications network, an acceptance from a particular tax professional licensed in the jurisdiction of the user; 3) initiating, over the communications network, a virtual conference between the user and the particular tax professional; 4) providing, over the communications network, a user interface configured for allowing the particular tax professional to enter user data and tax preparation data; 5) providing, over the communications network, an automated process that facilitates entry of user data and tax preparation data into the user interface; 6) storing said user data and said tax preparation data in one or more user records and tax preparation records in the database; 7) generating one or more tax return documents based on said user data and said tax preparation data; and 8) transmitting, over the communications network, the tax return documents to the tax authority.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE SEVERAL VIEWS OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a block diagram illustrating the network architecture of a system for providing financial services over a communications network, in accordance with one embodiment.

FIG. 2A is a block diagram showing the data flow of the process for providing financial services over a communications network, according to one embodiment.

FIG. 2B is a block diagram showing the main components of a system for providing financial services over a communications network, according to one embodiment.

FIG. 2C is a block diagram showing the tax preparation components of a system for providing tax preparation services over a communications network, according to one embodiment.

FIG. 3 is a flow chart depicting the general control flow of a process for providing tax preparation services over a communications network, according to one embodiment.

FIG. 4 is a block diagram depicting a system including an example computing device and other computing devices.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings. Likewise, the methods described herein may be modified by substituting, reordering, or adding stages to the disclosed methods. Accordingly, the following detailed description does not limit the claimed subject matter. Instead, the proper scope of the claimed subject matter is defined by the appended claims

The disclosed embodiments improve upon the problems with the prior art by providing a method and system that allows for the provision of a multitude of financial services, such as tax preparation services, all in one place. The user of the claimed embodiments is provided with one piece of software that a provides a variety of financial services, including credit card services, charge card services, tax preparation assistance services, real estate services, credit services, payroll services, health insurance services, and financial education services. Therefore, the disclosed embodiments reduce or eliminate the need for the user to access and interact with many different people and software in order to get all of the services above. This is advantageous for users and their provides, as it saves time and cuts down on having to enter the same information in several different places. An additional benefit of the disclosed embodiments is the flexibility in allowing users to prepare their own taxes, prepare their taxes with the assistance of a tax professional or to have a tax professional visit them to prepare their taxes. The main benefit of the claimed subject matter is the improvement of the conventional financial services experience.

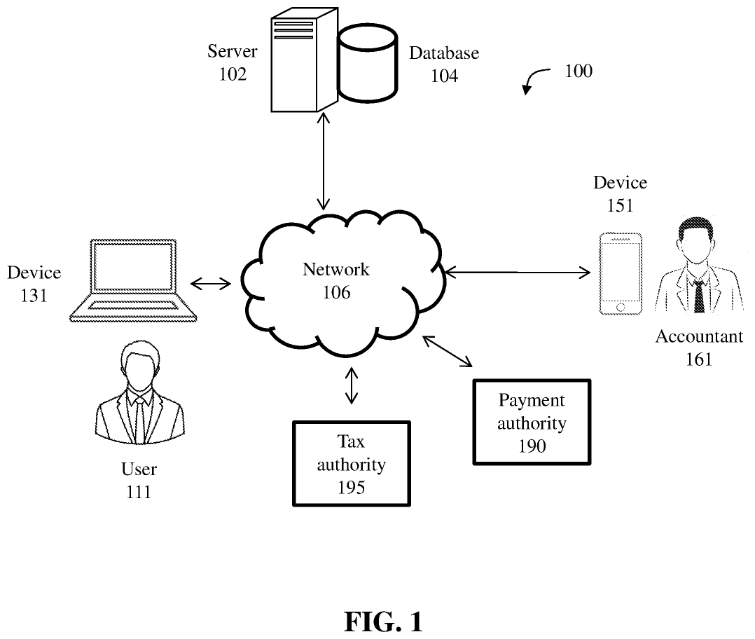

Referring now to the drawing figures in which like reference designators refer to like elements, there is shown in FIG. 1 an illustration of a block diagram showing the network architecture of a system 100 and method for providing financial services over a communications network in accordance with one embodiment. A prominent element of FIG. 1 is the server 102 associated with repository or database 104 and further communicatively coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, providing financial services.

FIG. 1 includes mobile computing devices 131 and 151, which may be smart phones, mobile phones, tablet computers, handheld computers, laptops, or the like. In another embodiment, mobile computing devices 131 and 151, are workstations, desktop computers, servers, laptops, all-in-one computers, or the like. In another embodiment, mobile computing devices 131 and 151, are AR or VR systems that may include display screens, headsets, heads up displays, helmet mounted display screens, or the like. Mobile computing device 131 corresponds to a customer or user 111 of financial services software. Mobile computing device 151 corresponds to a tax professional 161. Devices 102, 131, 151 may be communicatively coupled with network 106 in a wired or wireless fashion. Augmented reality (AR) adds digital elements to a live view often by using a camera on a computing device. Virtual reality (VR) is a complete or near complete immersion experience that replaces the physical world.

FIG. 1 further shows that server 102 includes a database or repository 104, which may be a database including a database management system. Devices 102, 131, 151 may also each include their own database. The repository 104 serves data from a database, which is a repository for data used by server 102 and devices 151, 131 during the course of operation of the disclosed embodiments. Database 104 may be distributed over one or more nodes or locations that are connected via network 106.

The database 104 may include a user record for each user 111 or tax professional 161. A user record may include: contact/identifying information for the user (name, address, telephone number(s), email address, etc.), information pertaining to financial services associated with the user, contact/identifying information for banks and bank accounts of the user, electronic payment information for the user, information pertaining to the credit history of the user, sales transaction data associated with the user, credit score of the user, etc. A user record may also include a unique identifier for each user, a residential address for each user, the current location of each user (based on location-based services from the user's mobile computer) and a description of past financial services purchased by each user. A user record may further include demographic data for each user, such as age, sex, income data, race, color, marital status, etc. A user record may also include contact information (email address, name, address, telephone number, etc.) or a unique identifier for one or more friends or acquaintances of the user.

Sales transaction data may include one or more product/service identifiers (such as SKUs), one or more product/service amounts, buyer contact/identifying information, financial services provider information, and electronic payment information. In one embodiment, electronic payment information may comprise buyer contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

The database 104 may include a tax preparation record for each user. A tax preparation record may include all of the information that is required for preparing and filing a tax return. A tax preparation record may include the social security number, tax ID number, full name and date of birth or the filer, his or her spouse and any children or dependents, as well as PIN numbers, routing and account numbers to receive a tax refund. A tax preparation record may also include income information for the filer, his or her spouse and any children or dependents, including W2 forms, 1099 forms, K1 schedules, and records for all expenses. A tax preparation record may further include childcare records (including the provider's tax ID number), asset information including cost, date placed in service, etc., tax payment information, rental asset information including cost, date placed in service, etc., retirement income data including pension/IRA/annuity income, traditional IRA basis, social security/RRB income and interest, dividend income, as well as income from sales of stock or other property , dates of acquisition and records of cost or other basis in property sold, etc. A tax preparation record may also include health savings account and long-term care reimbursements, expenses related to investments, records of estimated tax payments made, records for transactions involving cryptocurrency and records from other Income and losses, such as gambling income.

A tax preparation record may also include records of alimony paid/received, state tax refund data, mortgage interest statements, real estate and personal property tax records, receipts for energy-saving home improvements, records for charitable donations, records of medical expenses, amounts paid for healthcare, insurance, and to doctors, dentists, and hospitals, records for health insurance, records for childcare expenses, records for educational expenses and records for student loan interest. A tax preparation record may further include records of amounts of state and local income or sales tax paid, records showing amount of vehicle sales tax paid and/or personal property tax on vehicles, records for HSA contributions, IRA contributions, records for property losses (appraisal, clean-up costs, etc.), records of rebuilding/repair costs and insurance reimbursements/claims to be paid. A tax preparation record may further include tax return document which include all documents that are generated or calculated based on any data entered by the user or his tax professional, and which documents are submitted to the tax authority 195.

FIG. 1 shows an embodiment wherein networked computing devices 131, 151 interact with server 102 and repository 104 over the network 106. It should be noted that although FIG. 1 shows only the networked computers 131, 151 and 102, the system of the disclosed embodiments supports any number of networked computing devices connected via network 106. Further, server 102, and units 131, 151 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 131, 151. Further, server 102 and its functionality, according to a preferred embodiment, can be realized in a centralized fashion in one computer system or in a distributed fashion wherein different elements are spread across several interconnected computer systems.

FIG. 1 also shows a payment authority 190, which acts to effectuate payments by users 111 or 161 for financial services, or the like. In the course of a sales transaction, server 102 may interface with payment authority 190 to effectuate payment. In one embodiment, the payment authority 190 is a payment gateway, which is an e-commerce Application Service Provider (ASP) service that authorizes and processes payments from one party to another. The payment authority 190 may accept payment via the use of purchase cards, i.e., credit cards, charge cards, bank cards, gift cards, account cards, etc. FIG. 1 also shows a tax authority 195, which acts to effectuate tax laws and tax processes in a particular jurisdiction. In the course of a tax preparation transaction, server 102 may interface with tax authority 195 to effectuate the submission of a tax return. In one embodiment, the tax authority 195 is the United States Internal Revenue Service.

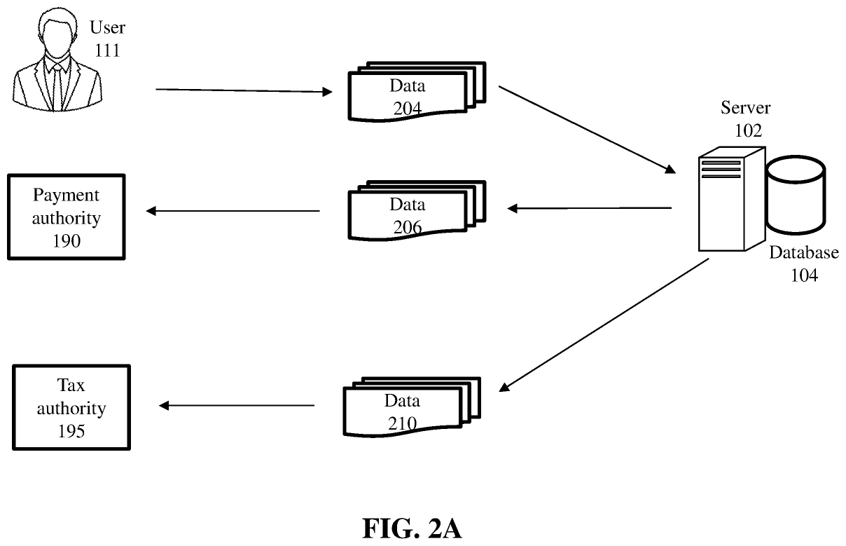

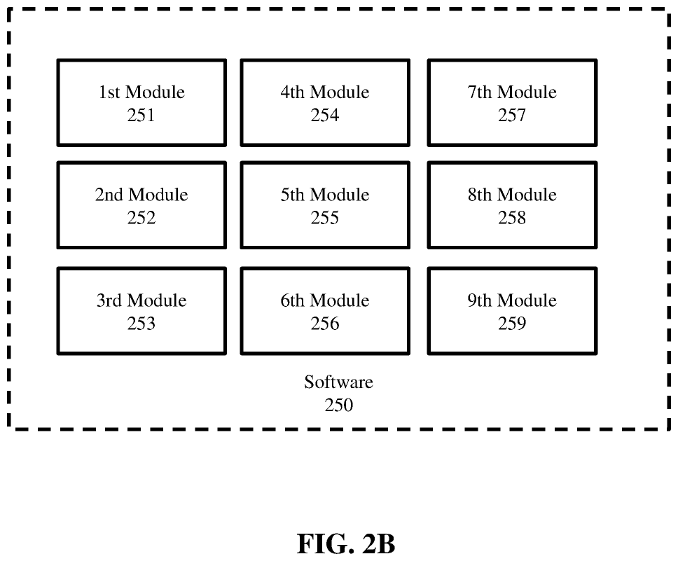

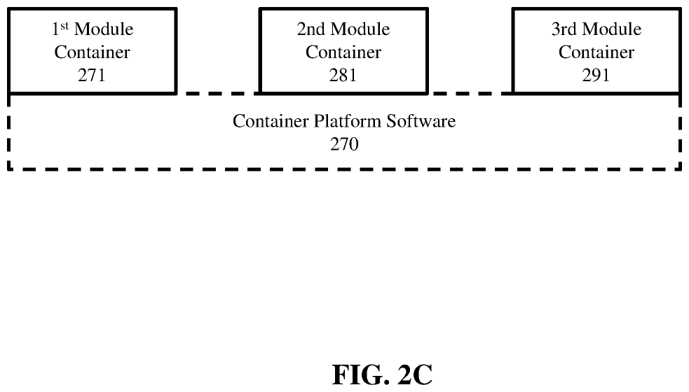

FIG. 2B is a block diagram showing the main components of the system 100 for providing financial services over a communications network, according to one embodiment. FIG. 2B shows that the main components of the system includes software 250 that is implemented as a mobile application or as a web service offered via a web site. In the case that the software 250 is implemented as a mobile application, downloadable software must be downloaded to a user's mobile device (such as 131 and 151), and there is a central server component of the software that resides on the server 102 and interacts with the user's mobile device. In this implementation, data is stored in the database 104 and served to the user's device. In the case that the software 250 is implemented as a web service offered via a web site, a web browser executes on a user's mobile device (such as 131 and 151), and there is a central server component of the software that resides on the server 102 and interacts with the user's mobile device. In this implementation, data is also stored in the database 104 and served to the user's device.

FIG. 2B shows that the software 250 includes a first module 251 configured for allowing a user or taxpayer 111 to prepare a tax return himself and submit it electronically to the tax authorities using software 250. A module is a software component or part of a program that contains one or more routines. The first module allows the user 111 to enter relevant tax data, such as any of the information that may be included in a tax preparation record, and guides the user through a series of questions and answers. All of the data entered by the user and all of the data that is calculated or generated by the software (such as summations, subtractions, itemizing of deductions and the preparation of tax forms) may be stored in a tax preparation record, and may be transmitted electronically via network 106 to the appropriate tax authority 195, such as the Internal Revenue Service.

The second module 252 is configured for allowing a taxpayer to request that a tax professional visit the user 111 in person at a desired location and a desired time to prepare a tax return and submit it electronically to the tax authorities. If this option is selected, the server 102 broadcasts, over the communications network, a message, to a group of available tax professional (such as accountant 161) licensed in the particular state where the customer 111 resides, the message indicating availability of the customer. The message may be sent via text, email, mobile application, etc. to the mobile computing devices of the tax professionals. In one embodiment, the message may prompt the group of available tax professionals to log into a secure system where the agent may view the new lead. In one embodiment, the server 102 accesses a stored list or array of data in an attached database that defines (by phone number, email address or other unique identifier used to communicate with said agent) which tax professionals are licensed in the particular state where the customer 111 resides and which tax professionals are nearest the user. Subsequently, once said subset of tax professionals have been identified by the server, the server broadcasts, over the communications network, the message, to said identified group of tax professionals. In one embodiment, a plurality of tax professionals that are licensed in the jurisdiction or state of the customer (and that are neatest the user) are notified at the same time, and each of said tax professionals may view the message in a graphical user interface. Any of said tax professionals may press on the message to indicate his acceptance or to indicate that he claims the lead.

Subsequently, one of said tax professionals (such as accountant 161) sends from his mobile device 151 (and server 102 receives) an acceptance from said accountant 161 licensed in the particular jurisdiction or state where the customer resides. Then, the server 102 may initiate an in person visit between the customer 111 and the particular accountant 161 at the time and place indicated by the customer. Said initiation may include exchanging, over the communications network, address information between the user and the particular tax professional. In one embodiment, during the visit, the server 102 provides to the accountant, over the communications network, an automated process that facilitates completion of the tax return. The automated process may include one or more of a bot, a web service or conditional logic that facilitates completion of the tax forms by reducing an amount of data that must be input by the accountant 161 into the tax forms. Using conditional logic, the accountant 161 is guided to ask only the questions necessary until all fields are completed as required to complete the application for this use case. Questions are presented to the accountant 161 in a sequence that is designed to facilitate the flow of information. During said visit, the accountant 161 solicits further data from the customer, which the accountant 161 inputs into the tax forms. All of the data entered by the user and/or the accountant and all of the data that is calculated or generated by the software (such as summations, subtractions, itemizing of deductions and the preparation of tax forms) may be stored in a tax preparation record, and may be transmitted electronically via network 106 to the appropriate tax authority.

The third module 253 is configured for allowing the user 111 or taxpayer to request a tax professional and virtually connect (such as via phone conference, video conference or other virtual conference) with said professional, who will prepare the tax return and submit it electronically to the tax authorities. If this option is selected, the server 102 broadcasts, over the communications network, a message, to a group of available tax professional (such as accountant 161) licensed in the particular state where the customer 111 resides, the message indicating availability of the customer. The message may be sent via text, email, mobile application, etc. to the mobile computing devices of the tax professionals. In one embodiment, the message may prompt the group of available tax professionals to log into a secure system where the agent may view the new lead. In one embodiment, the server 102 accesses a stored list or array of data in an attached database that defines (by phone number, email address or other unique identifier used to communicate with said agent) which tax professionals are licensed in the particular state where the customer 111 resides. Subsequently, once said subset of tax professionals have been identified by the server, the server broadcasts, over the communications network, the message, to said identified group of tax professionals. In one embodiment, a plurality of tax professionals that are licensed in the state of the customer are notified at the same time, and each of said tax professionals may view the message in a graphical user interface. Any of said tax professionals may press on the message to indicate his acceptance or to indicate that he claims the lead.

Subsequently, one of said tax professionals (such as accountant 161) sends from his mobile device 151 (and server 102 receives) an acceptance from said accountant 161 licensed in the particular state where the customer resides. Then, the server 102 may initiate a conference, over the communications network 106 or the public switched telephone network, between the customer 111 and the particular accountant 161. Further, the server 102 provides to the accountant, over the communications network, an automated process that facilitates completion of the tax return. The automated process may include one or more of a bot, a web service or conditional logic that facilitates completion of the tax forms by reducing an amount of data that must be input by the accountant 161 into the tax forms. Using conditional logic, the accountant 161 is guided to ask only the questions necessary until all fields are completed as required to complete the application for this use case. Questions are presented to the accountant 161 in a sequence that is designed to facilitate the flow of information. During said conference, the accountant 161 solicits further data from the customer, which the accountant 161 inputs into the tax forms. All of the data entered by the user and/or the accountant and all of the data that is calculated or generated by the software (such as summations, subtractions, itemizing of deductions and the preparation of tax forms) may be stored in a tax preparation record, and may be transmitted electronically via network 106 to the appropriate tax authority.

The fourth module 254 is configured for offering a prepaid charge card to the user 111. Said module is configured to solicit the information necessary for a charge card offer from the user 111, have him enter said data into the module, and electronically transmit an application for a charge card via network 106 to the issuing bank.

The fifth module 255 is configured for allowing a taxpayer to obtain assistance at any time from a customer service representative via a chat mechanism in the software, via the communications mechanisms on major social media platforms or via phone call. The fifth module is configured for allowing the user 111 or taxpayer to virtually connect (such as via phone conference, video conference or other virtual conference) with a customer service representative, who will assist the user. If this option is selected, the method in which a customer service representative is selected is similar or identical to the process described with reference to the second and third modules above.

The sixth module 256 is configured for providing one or more of the following services to the taxpayer: real estate investment services, credit repair services, bookkeeping services, payroll services, health insurance services, car loan services, and home mortgage services. Said module is configured to solicit the information necessary for a said services from the user 111, have him enter said data into the module, and electronically transmitting said information via network 106 to the servicing entity. The sixth module is configured for connecting the user 111 with a real estate investment firm, a credit repair firm, a bookkeeping firm, a payroll firm, a health insurance company, or a bank for car loan and home mortgage services such that said entities can service the user.

The seventh module 257 is configured for providing an ambassador program/affiliate program configured so that any customer can become a referral agent for pay. It is not required that the customer be a tax professional to earn extra income. An ambassador is a person employed by an organization to represent its brand in a positive light, helping to increase brand awareness and sales. The ambassador is meant to embody the corporate identity in appearance, demeanor, values and ethics. For each customer that the ambassador originates, a payment may be made to the customer. Said module is configured to solicit the information necessary for an ambassador program from the user 111, have him enter said data into the module, and electronically transmit an application for an ambassador program via network 106 to the issuing bank. The module is configured to pay the user a commission for each customer that he originates or converts.

The eighth module 258 is configured for providing virtual education software that provides training for all the services provided. Said module is configured for providing videos, a knowledge base and other teaching and educational material configured for teaching users how to prepare their taxes, or how to navigate and purchase real estate investment services, credit repair services, bookkeeping services, payroll services, health insurance services, car loan services, and home mortgage services.

The ninth module 259 is configured for providing a variety of contests (such as a talent competition) where contestants may win prizes, cash and vacations, such that talent can be recognized nationally and internationally. Said module is configured for providing text, web pages, videos, a knowledge base and other material configured for detailing the rules of the contests, including times, dates, requirements, and prizes.

FIG. 2C is a block diagram showing the tax preparation components of the system 100 for providing tax preparation services over a communications network, according to one embodiment. FIG. 2C shows that the first module 251 is deployed on the server 102 as a container 271, the second module 252 is deployed on the server 102 as a container 281, and the third module 253 is deployed on the server 102 as a container 291. The containers are executed on a container platform 270 deployed on the server 102. Container platform 270 may be a subset of, or a modular component of, software 250.

A container is a standard unit of software that packages up code and all its dependencies so the application runs quickly and reliably from one computing environment to another. A container image is a lightweight, standalone, executable package of software that includes everything needed to run an application: code, runtime, system tools, configuration files, system libraries and settings. Container images become containers at runtime. Available for most commercially available operating systems, containerized software will always run the same, regardless of the infrastructure. Containers isolate software from its environment and ensure that it works uniformly despite differences for instance between development and staging. Containers share the machine's (i.e., the computer on which the container is executing) operating system kernel and therefore do not require an operating system per application, leading to higher server efficiency and reducing server and licensing costs.

The containers operate on a platform as a service (PaaS) 270 that uses operating system-level (OS-level) virtualization on which containers execute. The PaaS can package an application and its dependencies in a virtual container that can run on any operating system. This enables the application to run in a variety of locations, such as on-premises, in public or private cloud. Because containers are lightweight, a single server or virtual machine can run several containers simultaneously. OS-level virtualization is an operating system paradigm in which the kernel allows the existence of multiple isolated user space instances.

Container orchestration is the automation of the operational effort required to run containerized workloads and services. Container orchestration includes items needed to manage a container's lifecycle, including provisioning, deployment, scaling (up and down), networking, and load balancing. Because containers are lightweight and ephemeral by nature, running them in production can quickly become a massive effort. A containerized application might translate into operating hundreds or thousands of containers, especially when building and operating any large-scale system. This can introduce significant complexity if managed manually. Container orchestration makes the operational complexity manageable because it provides a declarative way of automating the work.

As shown in FIG. 2C, the containers 271, 281, 291 execute on the container platform software 270. Among other things, the container platform software 270 includes container orchestration routines that manage provisioning, deployment, scaling (up and down), networking, and load balancing. Scaling is the act of handling a growing or decreasing amount of work placed on the containers by adding or subtracting resources to the system. The container platform software 270 executes dynamic scaling as follows. As the demand among consumers for a particular container increases, the container platform software 270 increases the instances of said container to handle the load. Therefore, as more consumers are requesting container 271, the container platform software 270 increases the instances of container 271 to handle the load. As the demand among consumers for a particular container decreases, the container platform software 270 decreases the instances of said container to free up resources. Thus, as fewer consumers are requesting container 271, the container platform software 270 decommissions or deallocates the instances of container 271 to free up resources.

The step of dynamically scaling said plurality of containers according to user demand for said plurality of containers operates as follows. The software evaluates demand for each of the first, second and third containers. If demand for any particular container of the first, second and third containers increases over a predefined threshold, creating one or more additional instances of said particular container. If demand for any particular container of the first, second and third containers decreases below a predefined threshold, deallocating one or more instances of said particular container. The steps above are executed repeatedly.

Load balancing refers to the process of distributing the load initiated by consumers over a set of containers, with the aim of making their overall processing more efficient. Load balancing optimizes the response time and avoid unevenly overloading some containers while other containers are left idle. The container platform software 270 executes dynamic load balancing as follows. The container platform software 270 distributes the number of requests for container 271 as evenly as possible among the multiple instances of the container 271, so as not to overload any one container or leave any container idle.

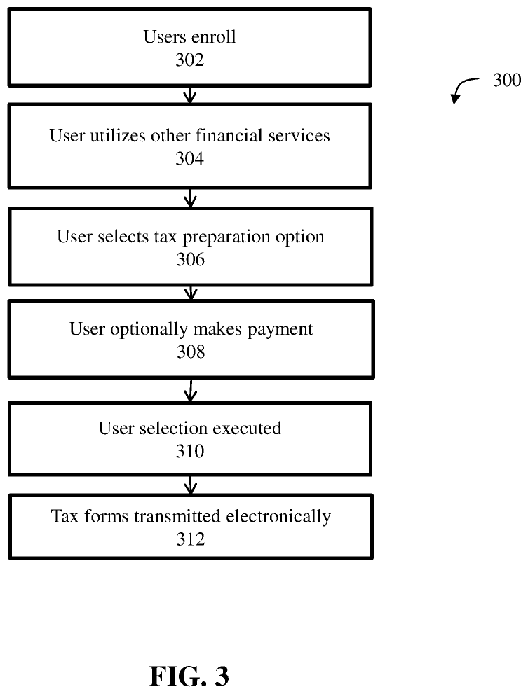

The process of providing financial services over a communications network will now be described with reference to FIGS. 2A and 3 below. FIGS. 2A and 3 depict the data flow and control flow, respectively, of the process for providing financial services, such as tax preparation services, over a communications network 106, according to one embodiment. The process of the disclosed embodiments begins with optional step 302 (see flowchart 300), wherein the users 111 and 161 may enroll or register with server 102. In the course of enrolling or registering, the users may enter data 204 into their device by manually entering data into a mobile application via keypad, touchpad, or via voice. In the course of enrolling or registering, the users may enter any data 204 that may be stored in a user record or tax preparation record, as defined above. Also in the course of enrolling or registering, the server 102 may generate a user record and/or tax preparation record for each registering user and store the user record and/or tax preparation record in an attached database, such as database 104.

Subsequently, in step 304, the user 111 engages with, or utilizes some of the financial services modules, such as modules 254-259. See above for a more detailed description of how modules 254-259 operate. The user 111 may utilize said modules on his mobile computing device 131.

In step 306, the user 111 is presented with the three tax preparation options of modules 251, 252, 253, and the user makes a selection. Modules 251, 252, 253 include allowing user 111 to prepare a tax return himself and submit it electronically to the tax authorities using software 250 (module 251), requesting that a tax professional visit the user 111 in person at a desired location to prepare a tax return and submit it electronically to the tax authorities (module 252) and allowing the user 111 to request a tax professional and virtually connect (such as via phone conference, video conference or other virtual conference) with said professional, who will prepare the tax return and submit it electronically to the tax authorities (module 253).

In step 308, the user optionally makes payment for the selection of step 306. Certain selections may require payment while other selections may not require payment. Electronic payment information presented by the user 111 when purchasing the tax preparation services is transmitted by server 102 (as data 206) to payment authority 190 for processing. The payment authority 190 processes the electronic payment information and verifies whether payment has been effectuated. If so, the payment authority 190 may send a verification message to the server 102 thereby verifying that the payment has been effectuated.

In step 310, the tax preparation services selected by the user are executed. See above for a more detailed description of how modules 251-253 operate. The user 111 may utilize said modules on his mobile computing device 131. In this step, the server 102 may generate and store in database 104 one or more tax preparation records and/or user records for the data entered or provided by the user 111. In step 312, the user's tax returns (data 210) are electronically transmitted to the tax authority 195 by the software 250.

In one embodiment, the system 100 includes an ambassador program for anyone to promote the services of the system. The “ambassador” receives a promo code to share and receives a commission for any consumer that signs up with that code. Said program is ideal for influencers, marketers, publishers, and famous people that are not necessarily in the financial industry and allows them earn extra money. Said program ties referrals to earnings.

In one embodiment, the system 100 includes a talent show, which is a talent contest that is designed to give artists an opportunity to show their talents on a national stage. The talent show is a contest that is held quarterly that allows contestants to win exclusive prizes and earn exposure on different stages across the country. The talent show provides the ability to connect with different artists and entrepreneurs through networking opportunities throughout the duration of the contest.

In one embodiment, the system 100 includes a customer service system operating 24/7. Customer service may be contacted through direct chat, email, or through the customer support team on a website or app.

In one embodiment, the system 100 facilitates an online tax filing service for customers to file their federal and state taxes and submit these taxes to the IRS using the modernized e-filing system, which is a web-based system that allows electronic filing (e-filing) of corporate, individual, partnership, exempt organization, and excise tax returns through the Internet. Only authorized providers can file taxes through this system.

In one embodiment, the system 100 includes a variety of different services aside from tax preparation, including real estate investments. Credit repair services are also offered that will contact credit reporting bureaus on the customer's behalf. In exchange for a fee, the system will remove inaccurate or negative information and help one improve credit over time. Bookkeeping services are also offered. Accounting services that record one's income, expenses and all financial transactions, prepare source documents for all transactions, operations and other events of a business. Payroll services are also offered. Payroll services handle the calculation of wages and taxes and the issuing of paychecks to employees of a company. Insurance services are also offered, including health insurance services. Virtual car dealership services are also offered, which provide a catalogue of new and used cars including all the information on the individual vehicles, such as pictures of the exterior and interior of the car, price, year, mileage, specs, accident reports (for used cars), etc. For new cars, the service provides the same information, minus an accident report and mileage.

Continuing educational services are also provided, including on entrepreneurship and finances, including accounting, bookkeeping, tax preparation, insurance, credit repair, real estate investments, trading, etc. Prepaid card services are also offered. Prepaid cards are a reloadable card that one can use to withdraw cash, pay bills, or make purchases at participating retailers and service providers, in-person or online. The card may be used to receive tax returns without a bank account and so one does not have to wait for a check. Truck dispatching services are also provided, which involve the logistics of truck dispatches for a company. Financial trading services are also provided for buying and selling financial assets in a foreign exchange.

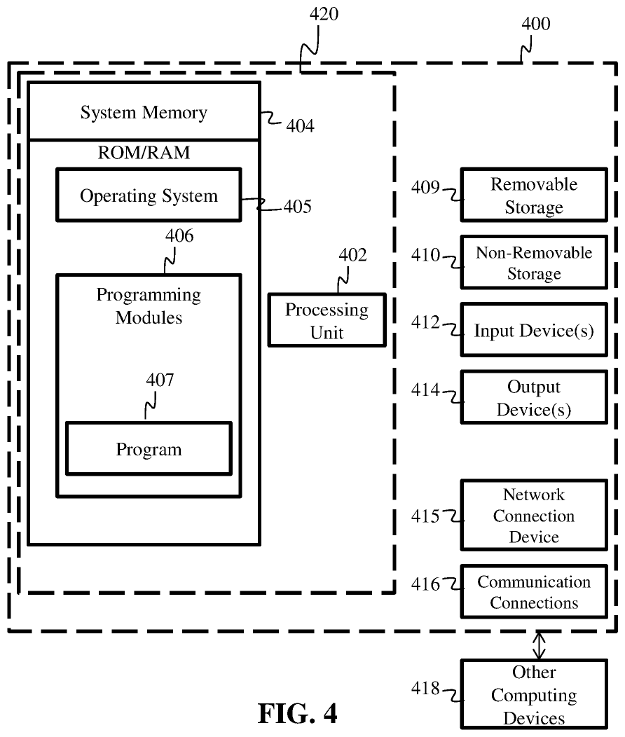

FIG. 4 is a block diagram of a system including an example computing device 400 and other computing devices. Consistent with the embodiments described herein, the aforementioned actions performed by devices 131, 151, 102 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and process 300, as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random-access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400′s operation. In one embodiment, programming modules 406 may include, for example, a program module 407 for executing the actions of devices 131, 151, 102. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. program module 407) may perform processes including, for example, one or more of the stages of the process 300 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system for providing tax preparation services to a user over a communications network, the computing system comprising:
a database configured for storing a plurality of user records and tax preparation records;
a web server communicably connected to the communications network and to the database, the web server including:
a) an operating system-level virtualization platform configured for hosting and executing a plurality of containers, and for dynamically scaling said plurality of containers according to user demand for said plurality of containers;
b) a first container executing on said platform, the first container configured for:
1) providing, over the communications network, a user interface configured for allowing the user to enter user data and tax preparation data;
2) reading, over the communications network, user data and tax preparation data entered by the user into the user interface;
3) storing said user data and said tax preparation data in one or more user records and tax preparation records in the database;
4) generating one or more tax return documents based on said user data and said tax preparation data;
5) transmitting, over the communications network, the tax return documents to a tax authority;
c) a second container executing on said platform, the second container configured for:
1) broadcasting, over the communications network, a message to a group of available tax professionals licensed in a jurisdiction of the user, the message indicating availability of the user;
2) receiving, over the communications network, an acceptance from a particular tax professional licensed in the jurisdiction of the user;
3) initiating, over the communications network, an in-person visit between the user and the particular tax professional;
4) providing, over the communications network, a user interface configured for allowing the particular tax professional to enter user data and tax preparation data;
5) providing, over the communications network, an automated process that facilitates entry of user data and tax preparation data into the user interface;
6) storing said user data and said tax preparation data in one or more user records and tax preparation records in the database;
7) generating one or more tax return documents based on said user data and said tax preparation data; and
8) transmitting, over the communications network, the tax return documents to the tax authority; and
d) a third container executing on said platform, the third container configured for:
1) broadcasting, over the communications network, a message to a group of available tax professionals licensed in a jurisdiction of the user, the message indicating availability of the user;
2) receiving, over the communications network, an acceptance from a particular tax professional licensed in the jurisdiction of the user;
3) initiating, over the communications network, a virtual conference between the user and the particular tax professional;
4) providing, over the communications network, a user interface configured for allowing the particular tax professional to enter user data and tax preparation data;
5) providing, over the communications network, an automated process that facilitates entry of user data and tax preparation data into the user interface;
6) storing said user data and said tax preparation data in one or more user records and tax preparation records in the database;
7) generating one or more tax return documents based on said user data and said tax preparation data; and
8) transmitting, over the communications network, the tax return documents to the tax authority.

2. The system of claim 1, wherein the step of providing, over the communications network, a user interface configured for allowing the user to enter user data and tax preparation data further comprises displaying the user interface on a mobile computing device of the user.

3. The system of claim 2, wherein the step of providing, over the communications network, a user interface configured for allowing the particular tax professional to enter user data and tax preparation data further comprises displaying the user interface on a mobile computing device of the tax professional.

4. The system of claim 3, wherein the step of initiating, over the communications network, an in-person visit between the user and the particular tax professional further comprises exchanging, over the communications network, address information between the user and the particular tax professional.

5. The system of claim 4, wherein the second container is further configured for processing an electronic payment from the user for tax preparation services.

6. The system of claim 5, wherein the third container is further configured for processing an electronic payment from the user for tax preparation services.

7. The system of claim 6, wherein the step of dynamically scaling said plurality of containers according to user demand for said plurality of containers further comprises:
a) evaluating demand for each of the first, second and third containers;
b) if demand for any particular container of the first, second and third containers increases over a predefined threshold, creating one or more additional instances of said particular container;
c) if demand for any particular container of the first, second and third containers decreases below a predefined threshold, deallocating one or more instances of said particular container; and
d) executing steps a), b) and c) repeatedly.
